(19) United States
(12) Patent Application Publication
(10) Pub. No.: US 2021/0232902 A1
(43) Pub. Date: Jul. 29, 2021

(54) Data Flow Architecture for Processing with Memory Computation Modules

(71) Applicant: Spero Devices, Inc., Acton, MA (US)

(72) Inventors: Jai Gupta, Westford, MA (US); Nihar Athreyas, Marlborough, MA (US); Abbie Mathew, Westford, MA (US); Marc Edouard Gauthier, Verdun (CA)

(21) Appl. No.: 17/156,172

(22) Filed: Jan. 22, 2021

Related U.S. Application Data
(60) Provisional application No. 62/964,760, filed on Jan. 23, 2020.
(60) Provisional application No. 63/052,370, filed on Jul. 15, 2020.

(51) Int. Cl. G06N 3/063; G06F 9/54; G06F 3/06; G06F 9/30

(52) U.S. Cl. CPC G06N 3/063; G06F 9/545; G06F 3/0656; G06F 3/0604; G06F 9/30036; G06F 9/3005; G06F 3/0688

(57) ABSTRACT

A high-endurance, computation-in-memory processor includes a plurality of memory computation modules (MCMs). Each of the MCMs comprise a plurality of memory arrays and a respective module controller to program the plurality of memory arrays to perform mathematical operations on a data set, as well as communicate with other of the MCMs to control a data flow between the MCMs. An inter-module interconnect transports operational data between the MCMs, and communicates with the MCMs to maintain queues storing the operational data during transport between the MCMs. A digital signal processor (DSP) transmits input data to the MCMs and retrieves processed data output by the MCMs.

### RELATED APPLICATIONS

This application claims the benefit of U.S. Provisional Application No. 62/964,760, filed on Jan. 23, 2020, and U.S. Provisional Application No. 63/052,370, filed on Jul. 15, 2020. The entire teachings of the above applications are incorporated herein by reference.

### GOVERNMENT SUPPORT

This invention was made with government support under contract number HR00111990073 from Defense Advanced Research Projects Agency (DARPA). The government has certain rights in the invention.

### BACKGROUND

The paradigm shift from Von Neumann architectures to computation-in-memory has the potential to dramatically lower energy consumption and increase throughput in carrying out AI computation. Defined herein is a hardware architecture combining novel Memory Computation Modules for multiply-accumulate computation-in-memory with a novel data flow architecture for optimal integration within standard computing systems, particularly to carry out computations within Artificial Intelligence.

### SUMMARY

Example embodiments include a computation-in-memory processor system comprising a plurality of memory computation modules (MCMs), an inter-module interconnect, and a digital signal processor (DSP). Each of the MCMs may include a plurality of memory arrays and a respective module controller configured to 1) program the plurality of memory arrays to perform mathematical operations on a data set and 2) communicate with other of the MCMs to control a data flow between the MCMs. The inter-module interconnect may be configured to transport operational data between at least a subset of the MCMs. The inter-module interconnect may be further configured to maintain a plurality of queues storing at least a subset of the operational data during transport between the subset of the MCMs. The DSP may be configured to transmit input data to the plurality of MCMs and retrieve output data from the plurality of MCMs.

The module controller of each MCM may include an interface unit configured to parse the input data and store parsed input data to a buffer. The module controller may also include a convolution node configured to determine a distribution of the data set among the plurality of memory arrays. The module controller may also include one or more alignment buffers configured to enable multiple memory arrays to be written with data of the data set simultaneously using a single memory word read. The module controller may be further configured to operate a number of the one or more alignment buffers based on a number of convolution kernel rows. The module controller of each MCM may further include one or more barrel shifters each configured to shift an output of the one or more alignment buffers into an array row buffer, the array row buffer configured to provide input data to a respective row of one of the plurality of memory arrays.

The mathematical operations may include vector matrix multiplication (VMM). The plurality of MCMs may be configured to perform mathematical operations associated with a common computation operation, the data set being associated with the common computation operation. The common computation operation may be a computational graph defined by a neural network, a dot product computation, and/or a cosine similarity computation.

The inter-module interconnect may be configured to transport the operational data as data segments, also referred to as “grains,” having a bit size equal to a whole number raised to a power of 2. The inter-module interconnect may control a data segment to have a size and alignment corresponding to a largest data segment transported between two MCMs. The inter-module interconnect may be configured to generate a data flow between two MCMs, the data flow including at least one data packet having a mask field, a data size field, and an offset field. The at least one packet may further include a stream control field, the stream control field indicating whether to advance or offset a data stream.

The plurality of MCMs may include a first MCM and a second MCM, the first MCM being configured to maintain a transmission window, the transmission window indicating a maximum quantity of the operational data permitted to be transferred from the first MCM to the second MCM. The first MCM may be configured to increase the transmission window based on a signal from the second MCM, and is configured to decrease the transmission window based on a quantity of data transmitted to the second MCM.

Further embodiments include a MCM circuit. A plurality of memory arrays may be configured to perform mathematical operations on a data set. An interface unit may be configured to parse input data and store parsed input data to a buffer. A convolution node may be configured to determine a distribution of the data set among the plurality of memory arrays. One or more alignment buffers may be configured to enable multiple memory arrays to be written with data of the data set simultaneously using a single memory word read. An output node may be configured to process a computed data set output by the plurality of memory arrays.

The plurality of memory arrays may be high-endurance memory (HEM) arrays. The circuit may be configured to operate a number of the one or more alignment buffers based on a number of convolution kernel rows. One or more barrel shifters may each be configured to shift an output of the one or more alignment buffers into an array row buffer, the array row buffer configured to provide input data to a respective row of one of the plurality of memory arrays.

Further embodiments include a method of computation at a MCM comprising a plurality of memory arrays and a module controller configured to program the plurality of memory arrays to perform mathematical operations on a data set. Input data is parsed via a reader node, and is stored to a buffer via a buffer node. The input data may then be read via a scanner node. At a convolution node, a distribution of a data set among the plurality of memory arrays may be determined, the data set corresponding to the input data. At the plurality of memory arrays, the data set may be processed to generate a data output.

At one or more alignment buffers, multiple memory arrays may be enabled to be written with data of the data set simultaneously using a single memory word read. At one or more barrel shifters, an output of the one or more alignment buffers may be shifted into an array row buffer.

Still further embodiments include a method of compiling a neural network. A computation graph of nodes having a plurality of different node types may be parsed into its constituent nodes. Shape inference may then be performed on input and output tensors of the nodes to specify a computation graph representation of vectors and matrices on which processor hardware is to operate. A modified computation graph representation may be generated, the modified computation graph representation being configured to be operated by a plurality of memory computation modules (MCMs). The modified computation graph representation may be memory mapped by providing addresses through which MCMs can transfer data. A runtime executable code may then be generated based on the modified computation graph representation. Further, data output of memory array cells of the MCMs may be shifted to a conjugate version in response to vector matrix multiplication in the memory array cells yielding an output current that is below a threshold value.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-D illustrate high-endurance memory circuitry in one embodiment.

FIG. 2 is a block diagram of a processing system in one embodiment.

FIG. 3A is a block diagram of a memory computation module (MCM) in one embodiment.

FIG. 3B illustrates an example data flow in the MCM of FIG. 3A.

FIG. 4 is a block diagram of a subset of an MCM in further detail.

FIG. 5 illustrates a convolution kernel in one embodiment.

FIG. 6 illustrates an output of an alignment buffer in one embodiment.

FIG. 7 illustrates a barrel shifter for an alignment buffer in one embodiment.

FIG. 8 illustrates a shifting operation by a set of alignment buffers in one embodiment.

FIG. 9 is a flow diagram illustrating compilation of a neural network in one embodiment.

FIG. 10 is a flow diagram of a compiled model neural network in one embodiment.

### DETAILED DESCRIPTION

A description of example embodiments follows.

Example embodiments described herein provide a hardware architecture for associative learning using a matrix multiplication accelerator, providing enormous advantages in data handling and energy efficiency. Example hardware architecture combines multiply-accumulate computation-in-memory with a DSP for digital control and feature extraction, positioning it for applications in associative learning. Embodiments further leverage locality sensitive hashing for HD vector encoding, preceded by feature extraction through signal processing and machine learning. Combining these techniques is crucial to achieving high throughput and energy efficiency when compared to state-of-the-art methods of computation for associative learning algorithms in machine vision and natural language processing.

Example embodiments may be capable of meeting the high-endurance requirement posed by applications such as Multi-Object Tracking. Recent work has considered the use of analog computation-in-memory to perform neural network inference computation. However, Multi-Object Tracking and related applications require much higher endurance than conventional computation-in-memory technologies such as floating gate transistors and memristors/Resistive RAM, due to the need to write some values for computation-in-memory at regular intervals (such as the frame rate of a camera).

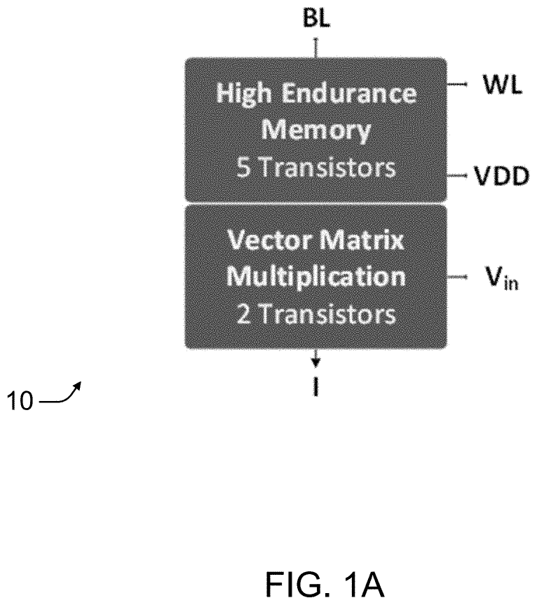

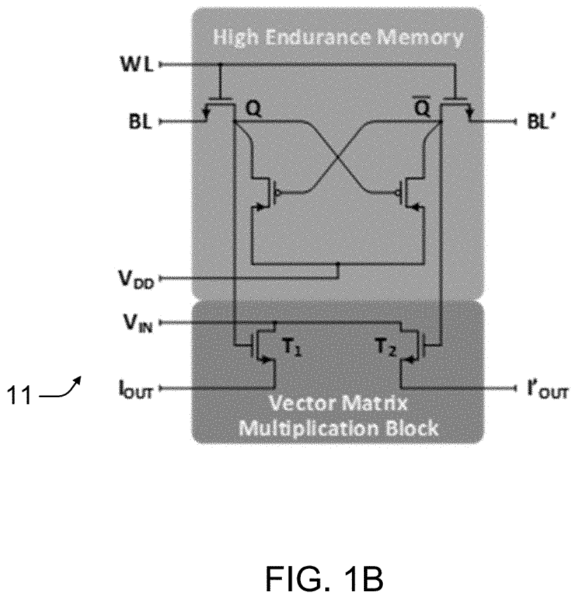

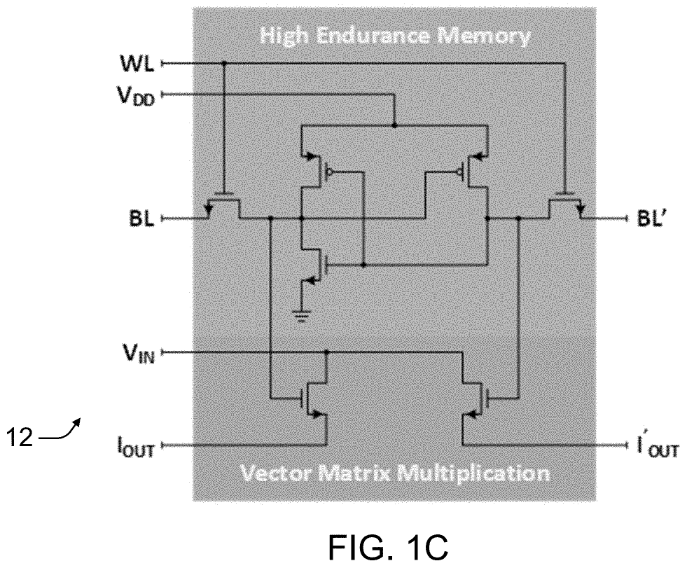

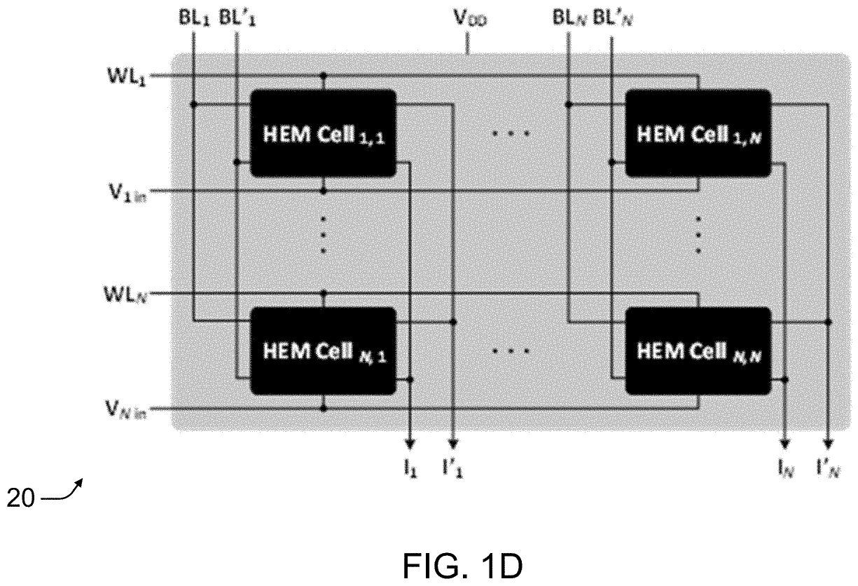

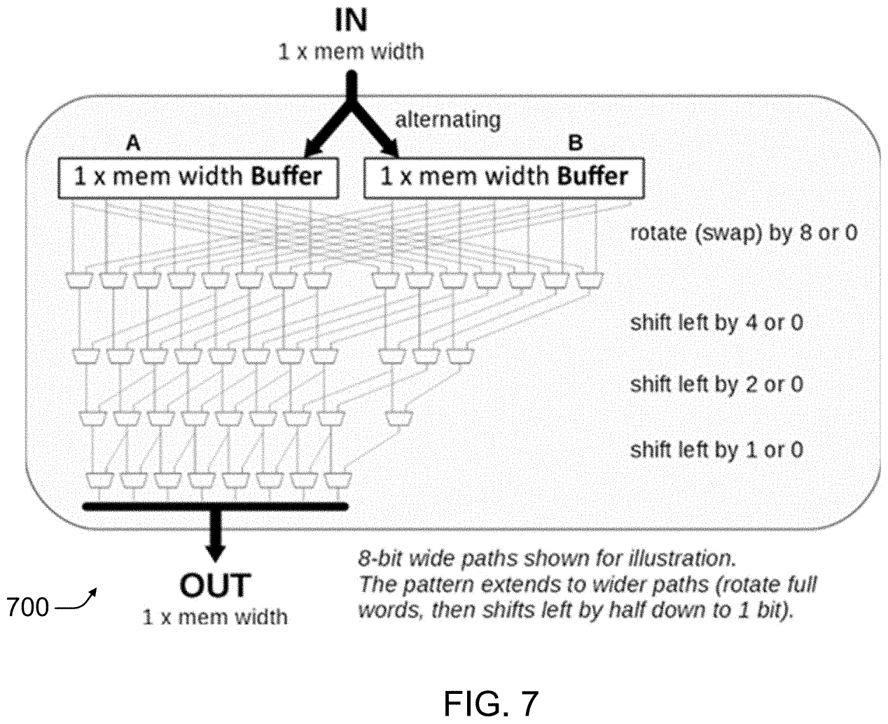

FIG. 1A illustrates the high-level architecture of a high-endurance memory (“HEM”) cell 10, which may be implemented in the embodiments described below. the cell 10 may comprise two parts; the first part is the High Endurance Memory Latch (HEM, shown in pink) block and the second part is the vector matrix multiplication (“VMM”) block (shown in green). The HEM Latch block consists of a memory latch formed by a transistor network, usually 4-5 transistors arranged as a cross-coupled pair (2T, 3T or 4T configuration) and which may include 1 or 2 access transistors. In one embodiment, the HEM latch block is built using a 2-transistor latch with 2 access transistors, as is used in a 4 transistor SRAM cell. In an alternative embodiment a 3-transistor latch can be used with 2 access transistors. The VMM block adds two additional transistors to the HEM block to form a 6T (depicted in FIG. 1b) or 7T (depicted in FIG. 1c) HEM cell. Parameters may be varied in each individual transistor to optimize the HEM cell to influence performance, including threshold voltage (LVT, SVT, HVT), gate sizing and operating voltages. The HEM latch block in combination with the VMM block perform VMM computation-in-memory operations.

The HEM cell can either operate in a High Resistance State (“HRS”) or Low Resistance State (“LRS”). To set up a LRS in the HEM cell, a logic “1” has to be written into the HEM and to set up a HRS, a logic “0” has to be written into the HEM. In order to store a logic “1” in the cell, Bit Line (BL) is charged to VDD and BL′ is charged to ground and vice versa for storing a logic “0”. Then the Word Line (WL) voltage is switched to VDD to turn “ON” the NMOS access transistors. When the access transistors are turned on, the values of the bit-lines are written into Q and Q′. The node that is storing the logic “1” will not go to full VDD because of a voltage drop across the NMOS access transistor. After the write operation, the WL voltage is reset to ground to turn “OFF” the NMOS access transistors. The node with the logic “1” stored will be pulled up to full VDD through the PMOS driver transistors. The states of the High Endurance Memory are shown in Table 1 below.

The voltage and its complement at nodes Q and Q′ will be applied to the gates of the two NMOS transistors in the VMM block. Depending on whether Q is logic “1” or logic “0”, LRS or FIRS will be set up at the NMOS transistors in the VMM block respectively. The input voltage VIN is applied to the drain of the two NMOS transistors in the VMM block. This will result in an output current and its complement, which are denoted as I_{OUT} and I′_{OUT}. This output current represents a multiplication between the input voltage VIN and the resistance state of the NMOS transistors. The values of I_{OUT} and I′_{OUT} is shown in Table 2.

TABLE 1
Logic table that determines the states (Q and Q′)
of the 6T High Endurance Memory embodiment. After the
write operation, WL can be at ground. VDD, as shown
in FIG. 1, must always be applied to maintain the states.

| WL | BL | BL′ | Q | Q′ |
|---|---|---|---|---|
| VDD | VDD | Ground | 1 | 0 |
| VDD | Ground | VDD | 0 | 1 |

TABLE 2
Logic table that determines the resistance level of NMOS
transistors T₁ and T₂, and output currents I_{OUT} and I′_{OUT}.

| Q | Q′ | V_{IN} | T₁ | T₂ | I_{OUT} | I′_{OUT} |
|---|---|---|---|---|---|---|
| 1 | 0 | 0 or 1 | LRS | HRS | V_{IN} ÷ LRS | V_{IN} ÷ HRS |
| 0 | 1 | 0 or 1 | HRS | LRS | V_{IN} ÷ HRS | V_{IN} ÷ LRS |

FIGS. 1B and 1C are circuit diagrams illustrating particular implementations of the HEM cell 10 of FIG. 1A. In particular, FIG. 1B illustrates a 6T HEM cell 11, and FIG. 1C illustrates a 7T HEM cell 12.

FIG. 1D illustrates a plurality of HEM cells arranged in a crossbar array configuration to form a HEM array 20. This crossbar array architecture is conducive to performing vector matrix multiplication operations. A matrix of binary values is written/stored in the HEM of each cell on a row-by-row (or column-by-column) basis in the HEM array. This is achieved by applying a VDD on the WL of a row (or column) and applying the appropriate voltages on the BLs and BL's of each column (or row). This is repeated for each row (or column). Once the values are written/stored on all the HEM cells, the input voltages are applied to Vin of each row in parallel. This results in a multiplied output current in each HEM cell which will be accumulated on each of the columns. The result is a VMM operation between the matrix of values stored and the input voltage vector applied to the rows.

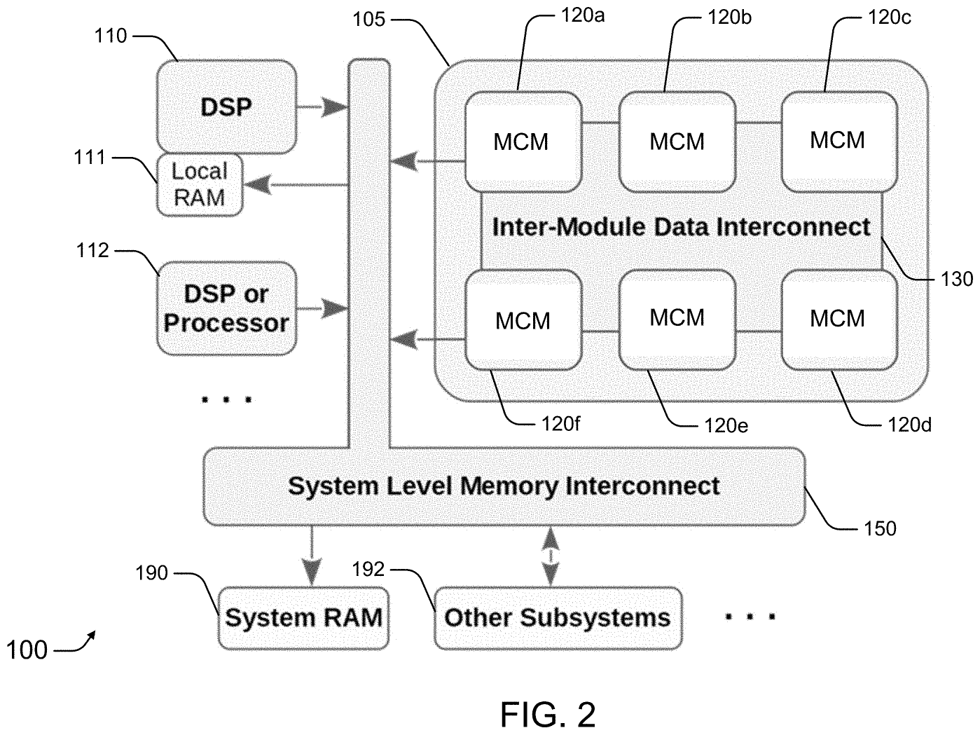

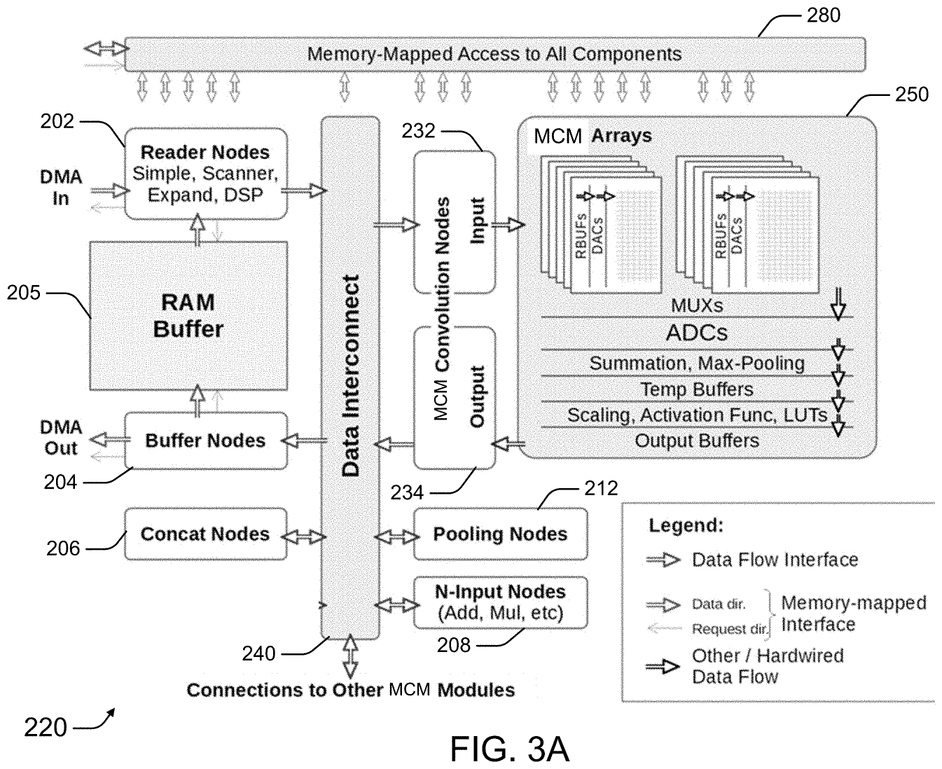

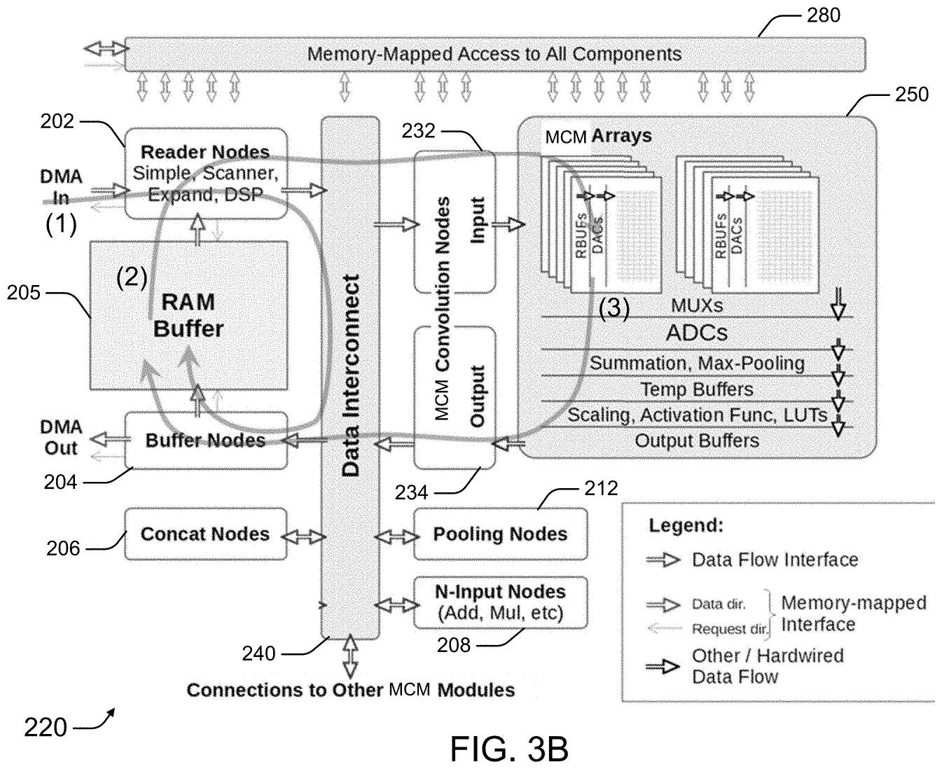

FIG. 2 is a block diagram of a processing system 100 implementing a memory computation assembly 105. Some or all of the system 100 may be implemented as a system-on-chip (SoC) subsystem that incorporates a set of memory computation modules (MCMs) 120a-f. Each of the MCMs 120a-f may comprise a plurality of memory arrays and a respective module controller configured to program the plurality of memory arrays to perform mathematical operations (e.g., vector matrix multiplication (VMM)) on a data set, as well as communicate with other of the MCMs to control a data flow between the MCMs. An example MCM is described in further detail below with reference to FIG. 3, and may implement HEM cells and HEM arrays as described above with reference to FIGS. 1A-D. Because connections between components may be made substantially through memory-mapped interconnects, actual system topologies may vary significantly from the layout shown in FIG. 2 as driven by specific requirements.

The MCMs 120a-f may communicate data amongst each other through a dedicated inter-module data interconnect 130 using a queue-based interface as described in further detail below. The interconnect 130 may be configured to transport operational data between the MCMs 120a-f, and may communicate with the MCMs 120a-f to maintain a plurality of queues storing at least a subset of the operational data during transport between the subset of the MCMs 120a-f. This interconnect 130 may be implemented using standard memory interconnect technology using unacknowledged write-only transactions, and/or provided by a set of queue network routing components generated according to system description. The topology of the interconnect 130 may also be flexible and is driven foremost by the physical layout of MCMs 120a-f and their respective memory arrays. For example, a mesh topology allows for efficient transfers between adjacent modules with some level of parallelism and with minimal data routing overhead. The MCMs 120a-f may be able to transfer data to or from any other module. An example system description, provided below, details the incorporation of latency and throughput information about the actual network to allow software to optimally map neural networks and other computation onto the MCMs 120a-f.

A digital signal processor (DSP) 110, as well as one or more additional DSPs or other computer processors (e.g., processor 112), may be configured to transmit input data to the plurality of MCMs 120a-f and retrieve output data from the plurality of MCMs 120a-f. One or more of the MCMs 120a-f may initiate a direct memory access (DMA) to the general memory system interconnect 150 to transfer data between the MCMs and DSPs 110, 112 or other processors. The DMA may be directed where needed, such as directly to and from a DSP's local RAM 111 (aka TCM or Tightly Coupled Memory), to a cached system RAM 190, and other subsystems 192 such as additional system storage. Although using the local RAM 111 may generally provide the best performance, it may also be limited in size; DSP software can efficiently inform the MCM(s) 120a-f when its local buffers are ready to send or receive data. Alternatively, the DSP 110 and other processors may directly access MCM local RAM buffers through the memory interconnect 150. MCM configuration may be done through this memory-mapped interface.

Interrupts between DSP and MCMs may be memory-mapped or signaled through dedicated wires.

All queues may be implemented with the following three interface signals:
a)<QUEUE>_DATA (w bits) Queue data
b)<QUEUE>_VALID (1 bit) Queue data is valid/available (same direction as queue data)
c)<QUEUE>_READY (1 bit) Recipient is ready to accept queue data (opposite direction to queue data)

The same interface may hold for any direction. The directions of VALID and READY bits are relative to that of DATA. A queue transfer takes place when both VALID and READY signals are asserted in a given cycle. The READY signal, once asserted, stays asserted with unchanging DATA until after the data is accepted/transferred. It is possible to transfer data every cycle on such a queue interface.

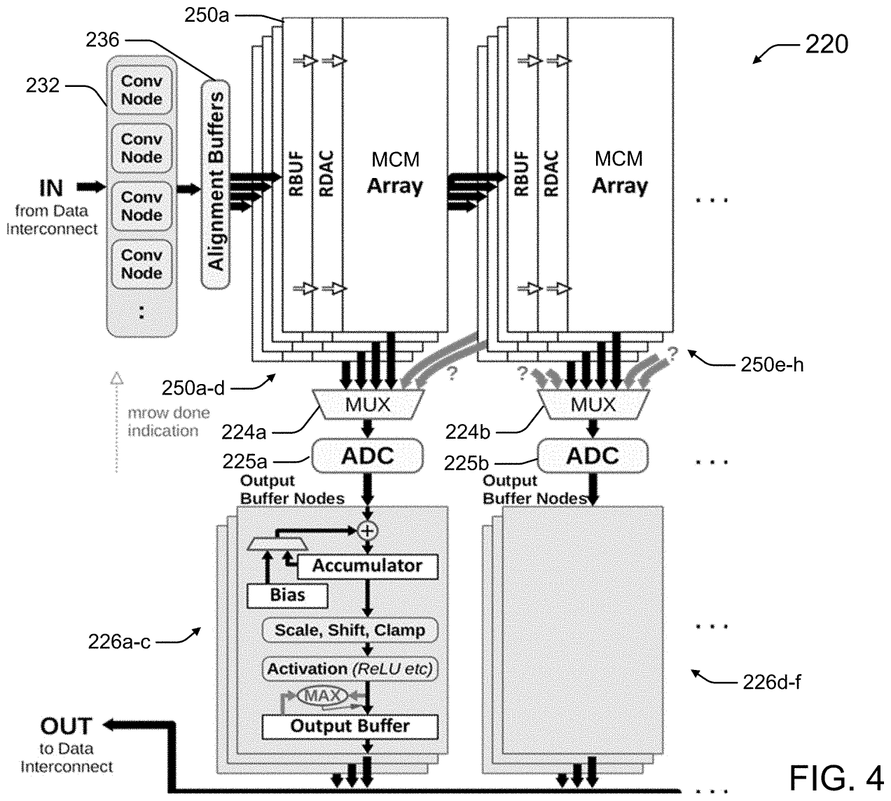

FIG. 3A is a block diagram of a MCM 220 in further detail. The MCMs 120a-f described above may each incorporate some or all features of the MCM 220 described herein. Each MCM 220 in a system (e.g., system 100) may be configured with a different set of resources and various parameters. The MCM may include a set of memory arrays 250 and several nodes described below, which may operate collectively as a module controller to program the memory arrays 250 to perform mathematical operations on a data set, as well as to communicate with other MCMs of a system to control a data flow between the MCMs. The memory arrays may include multiple arrays of memory cells, such as HEM cells and arrays described above with reference to FIGS. 1A-D, as well as interface circuitry described below with reference to FIG. 4.

The MCM 220 may be viewed as a data flow engine, and may be organized as a set of nodes that receive and/or transmit streaming tensor data. Each node may be configured, via hardware and/or software, with its destination and/or source, such that an arbitrary computation graph composed of such nodes, as are available, may be readily mapped onto one or more MCMs of a system. Once the MCM 220 is configured and processing is initiated, each node may independently consume its input(s) and produce its output. In this way, data naturally flows from graph inputs, through each node, and ultimately to graph outputs, until computation is complete. All data streams may be flow-controlled and all buffers between nodes may be sized at configuration time. Nodes may arbitrate for shared resources (such as access to the RAM buffer, data interconnect, shared ADCs, etc.) using well-defined prioritization schemes.

Reader nodes 202 may include a collection of nodes for reading, parsing, scanning, processing, and/or forwarding data. For example, a reader node may operate as a DMA input for the MCM 220, reading data from the system RAM 190, local RAM 111 or other storage of the system 100 (FIG. 1). The reader node may transfer this data to the module 220 by writing it to a RAM buffer 205 via a module data interconnect 240 and buffer nodes 204. The reader nodes 202 may also include a scanner node configured to access the data from the RAM buffer 205, parse it, and transfer it to other nodes such as an input convolution node 232. The input convolution node 232 may include one or more nodes configured to determine a distribution of the data set among the memory arrays 250. Similarly, output convolution nodes 234 may collect processed data from the memory arrays 250 for forwarding via the data interconnect 240. The buffer nodes 204 may also output processed data (e.g., via a DMA output operation) to one or more components of the system.

Concat nodes 206 may operate to concatenate outputs of one or more prior processing nodes to enable further processing on the concatenated result. Pooling nodes 212 may include MaxPool nodes, AvgPool nodes, and other pooling operators, further described below. N-Input nodes 208 may include several operators, such as Add, Mul, And, Or, Xor, Max, Min and similar multiple-input operators. The nodes may also include Single-Input (unary) nodes, which may be implemented as activations in the output portion of MCM array-based convolutions, or as software layers. Hardware nodes that do unary operations include, for example, cast operators for conversion between 4-bit and 8-bit formats, as well as new operators that may be needed for neural networks that are best handled in hardware.

Some or all components of the MCM 220 may be memory-mapped via a memory-mapping interface 280 for configuration, control, and debugging by host processor software. Although data flowing between MCMs and DSPs or other processors may be accessed by the latter by directly addressing memory buffers through the memory-mapped interface, such transfers are generally more efficient using DMA or similar mechanisms. Details of the memory map may include read-only offsets to variable-sized arrays of other structures. This allows flexibility in memory map layout according to what resources are included in a particular MCM hardware module. The hardware may define read-only offsets and sizes and related hardwired parameters; a software driver may read these definitions and adapt accordingly.

All data within the MCM 220 may flow from one node to the next through the data interconnect 240. This interconnect 240 may be similar to a memory bus fabric that handles write transactions. Data may flow from sender to receiver, and flow control information flows in the opposite direction (mainly, the number of bytes the receiver is ready to accept). The sender may provide a destination ID and other control signals, similar to a memory address except that a whole stream of data flows to the same ID. The data interconnect uses this ID to route data to its destination node. Conversely, the receiver may provide a source ID to identify where to send flow control and any other control signals back to the sender. In a memory subsystem, the source ID may be provided by the sender and aggregated onto by the bus fabric as it routes the request. While this can also be done in the MCM 220, another option is for software to pre-configure the source ID in each destination node. This allows destination nodes to inform their sender of their ability to receive data before the sender sends anything; another possibility is to configure a preset indicating that every receiver can receive one memory width of data at start of processing (this may not be true of the convolution nodes 232, 234, yet it can be made true when implementing aligning buffers).

Buffers for each node may be sized appropriately (e.g., preset or dynamically) between certain nodes so as to balance data flows replicated along multiple paths then synchronously merged, to ensure continuous data flow (i.e., avoid deadlock). This operation may be managed automatically in software and is described in further detail below.

FIG. 3B illustrates an example data flow in the MCM of FIG. 3A, demonstrating how input image data is accessed by a reader node 202 onto the data interconnect 240, routed to the buffer node 204 and stored in a RAM buffer 205 (1). The data may then be read in a kernel pattern by a scanner reader node, routed to the input convolution node 232 to be processed by the memory arrays 250 (alternatively, a Correlation or Dot Product Node may operate in place of the convolution node 232 when correlation or dot product computation is required instead of convolution) (2). The data processed by the memory arrays 250 may then be read out by the convolution output node 234 and routed through the data interconnect 240 and buffer nodes 204 to the RAM buffer 205 (3). From this stage, the processed data may be routed to other nodes (e.g., nodes 206, 212, 208) for further processing, or output by the buffer nodes 206 to an external component of the system, such as another MCM or a DSP.

FIG. 4 is a block diagram of a subset of the MCM 220 in further detail. The convolution nodes 232 may each serve as a distribution point for a single convolution spread across one or multiple memory arrays 250 (referenced individually as memory arrays 250a-h), which may perform vector-matrix multiplication computation-in-memory. This operation may be followed by processing at output nodes 226a-f, which may operate accumulation (e.g., with added bias), scaling (and/or shifting and clamping), non-linear activation functions, and optionally max-pooling, the result of which may proceeds to a subsequent node through the data interconnect 240.

Data processed by the memory arrays 250a-h may be routed by respective multiplexers (MUX) 224a-b to respective analog-to-digital converters (ADC) 225a-b for providing a corresponding digital data signal to the output nodes 226a-f. Each ADC 225a-b may multiplex data from either a dedicated set of MCM arrays or from nearby MCM arrays shared with other ADCs. The latter configuration can provide greater flexibility at some incremental cost in routing, and an optimal balance can be gauged through feedback observed from mapping a wide set of neural networks. Each ADC 225a-b may output either to a dedicated set of the output nodes 226a-f or to other nearby output buffer nodes that may be shared with other ADCs.

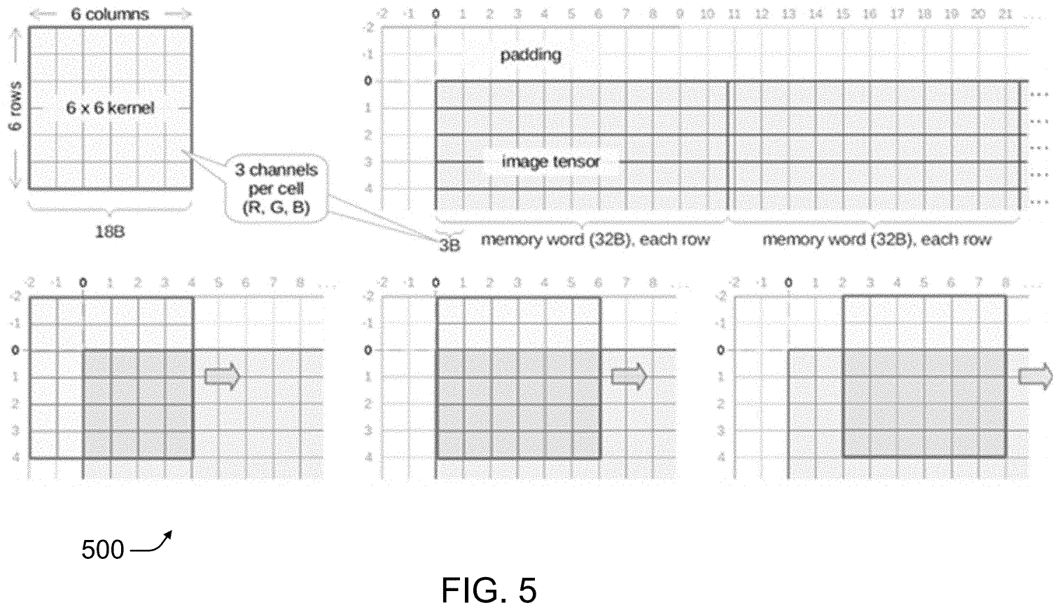

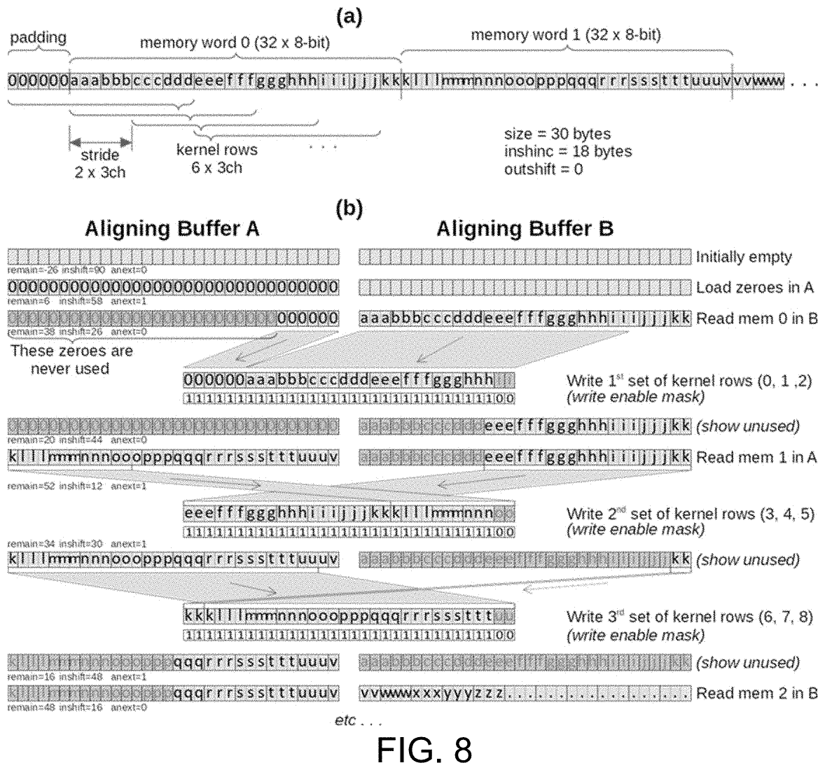

FIG. 5 illustrates an example 6×6 convolution kernel 500, and depicts one way weights may be mapped onto multiple MCM arrays to use aligning buffers as in the example described below with reference to FIG. 8. This example uses three MCM arrays, each with 32 columns×192 rows, to process the first convolution layer of the object detection neural network YoloV5s. This layer has a 6×6 kernel, stride 2, and 2 cells of padding. Data from each of the 6 convolution kernel rows is fed to corresponding aligning buffers.

A straightforward mapping of this kernel onto a MCM array is to fill the array with 32 columns (for each of the 32 output channels) and 108 rows (6×6×3 input channels). Assuming a memory width of 32 elements (256 bits for 8-bit elements), the scanner reader can read a whole row of 18 elements at once and send them to the array as 6 data transfers. Occasionally the 18 elements cross word boundaries and are read as two words, perhaps using RAM banking to do so in a single cycle. Making 6 transfers involves at least 6 cycles per kernel invocation: with a 3 cycle MCM array compute time, the MCM array is idle at least half the time. In practice, the idle time is much more pronounced. The RBUFs advertise their readiness for the next 6 transfers once compute is complete, which takes several cycles to reach the scanner reader, then read the next rows of data, then send them to the RBUFs. One way to reduce this extreme inefficiency is to double-buffer the RBUFs. In this case there is a lot of image pixel overlap from one invocation of the kernel to the next: taking advantage of this to reduce transfers can involve a lot of non-trivial shuffling of data among RBUFs.

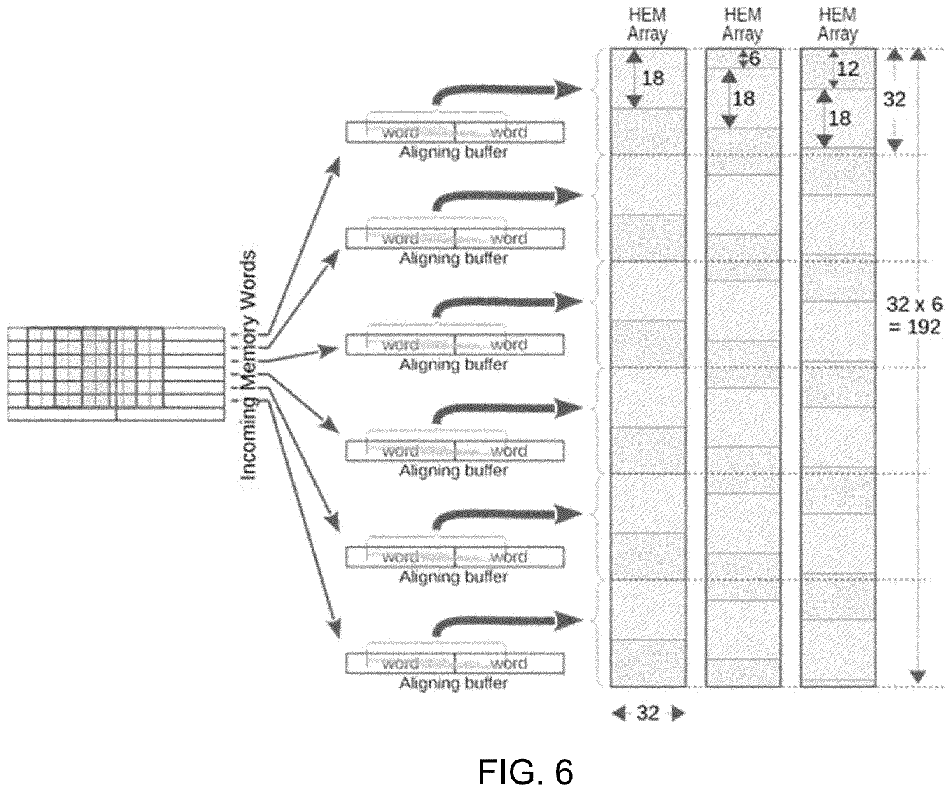

FIG. 6 illustrates example replicated MCM array weights for parallel computation from alignment buffers. An alternative method to avoid repeatedly sending the same data, and at the same time provide extra buffering to reduce latency, is to manage the overlap row-wise: use separate buffers for each row, and use an aligning buffer to shift data as it arrives, re-using repeated data without resending it. FIG. 6 depicts this scenario. A full memory word is read from the image for each of the 6 rows of the kernel and sent to a corresponding aligning buffer. Each aligning buffer extracts (shifts) the required portion of the one or two words that contain 3 successive overlapping kernel rows (for 3 successive invocation of the kernel) and sends it to a corresponding portion of the MCM array RBUF. This example uses three MCM arrays, each with 32 columns×192 rows (in 6 groups of 32 rows), to process the first convolution layer of YoloV5s.

The above example uses 32 elements per memory word. Using 64 elements per word provides more potential parallelism, and even larger number of elements per memory word are also possible. Feeding more than one MCM array per cycle may require a fair bit of extra routing and area, depending on overall topology and layout. Means to interconnect and layout arrays and buffers such that some level of parallelism occurs naturally are pursued herein. If each RBUF has its own aligning buffer, it is possible to pack the MCM arrays more tightly. However, weights are relatively small in the first layers, so some sparsity might not be very significant even with replication. The prime concern for these first layers is performance, such as data flow parallelism.

Alignment buffers can also be valuable for other layers. For example, YoloV5s' second layer can make use of alignment buffers. Here, there are four 1×1 Cony layers with 32 input channels that can make some use of buffering when memory width is wider than 32 elements (e.g., 64×8=512 bits). Most of the remaining 3×3 Cony layers are already memory word aligned so they have no need for the aligning barrel shifter. They can make good use of buffering to reduce repeated reading of the same RAM contents, and either a new separate buffer or the existing RBUFs may be used for this purpose.

FIG. 7 illustrates a barrel shifter 700 (also referred to as an alignment shifter) for an alignment buffer. Alignment buffers may be buffers with a variable shift. These data alignment blocks may implemented in various areas of an example system (e.g., between Cony nodes and MCM arrays particularly, as well as additional nodes.) They each consist of two or more buffers, each one memory word wide, and a barrel shifter that selects data from two adjacent buffers and outputs one memory word of data. This variable shifter may be implemented as a barrel shifter as shown in FIG. 7. An enable mask is produced along with output data, identifying which parts of the data thus shifted are being sent onwards.

In one example implementation, each alignment buffer shifter is configured with:
a) inshift: an input shift amount (0<=inshift<2*mem width)
b) size: size of data to extract and output (0<size<=mem width)
c) outshift: output shift amount (0<=outshift<=mem width−size)
d) inshinc: input shift amount increment to apply for each successive data output (0<inshinc<=mem width)
e) anext: a bit that tracks which of the two buffers (A or B) contains the oldest data (next to output)
f) remain: a counter of how much data is left in the buffers (0<=remain<=2*mem width)

The alignment shifter may anticipate a contiguous sequence of data on input, one whole mem width of data at a time. It essentially chops up this incoming data into chunks of size units (bytes or bits or whatever unit of measure) at start-to-start offsets of inshinc from each other, and outputs each one, one at a time, at an offset of outshift within the output word. If size==inshinc, it extracts successive chunks. If size>inshinc, the chunks overlap on input, as is common with convolution and maxpool kernels. If size<inshinc, there is a gap of inshinc−size between each chunk on input. Data in the output word outside the size bits starting at outshift may be ignored by the receiver and are generally whatever comes out of the barrel shifter. When there are more than 2 buffers, they may be arranged as a banked register file (i.e., two adjacent register files).

Initially, all fields may be initialized by software. In one example, initial settings include anext=0 and remain=0. However, software may set remain to a “negative number” (modulo its bitsize) when data starts in the middle rather than the start of the first received word. For example, data might start with less than a mem width of padding, with padding provided as a full word of zeroes, so that subsequent memory accesses are aligned.

At every step during its operation, each alignment shifter may function in a way equivalent to this:
a) If remain<=mem width, accept another word. If remain<=0, accept two words.
b) If remain>=size and remain>=inshinc:
   i. shift=inshift−outshift
   ii. output data=(anext\hat{ }(shift<0)?{A,B}: {B,A})<<<(shift & (mem width−1))
   iii. output enablemask=outshift×‘1b0, size×‘1b1, mem width−outshift−size×‘1b0
   iv. output indication that data is ready
c) If output is consumed (signaling may be such that this can happen in the same cycle as output):
   i. remain−=inshinc
   ii. inshift+=inshinc
   iii. clear indication that data is ready
d) If a word arrives:
   i. remain+=mem width
   ii. inshift−=mem width
   iii. anext \hat{ }=1

In this example, only a whole mem width of data is received at a time. Several of the parameters may need to be reset at the start of each row (e.g., to handle padding correctly). Handling padding at the end of the row, which may not be word-aligned, is done by putting the last word through the alignment shifter and storing it back in one of the aligning buffers (instead of outputting it) before doing another barrel shift to output it along with the zeroes word.

FIG. 8 illustrates an example alignment shifter sequence for the first convolution layer in YoloV5s. It processes an input image (3 channels of 8-bit RGB) using a 6×6 kernel, stride 2, and 2 cells of padding. In this example, memory width is 256-bit (32×8-bit). A separate alignment shifter may be used for each of the 6 rows of the kernel.

Data Flow Interfaces

Turning again to FIG. 3A, data flowing to and from the module data interconnect 240, and in some other places, may go through a specific data flow interface. Each interface may operate in two directions: forward data flow, and flow control information in the reverse direction.

Data sent over data flow interfaces may be sized in “grains”: the granularity of both data size and alignment. Granularity, or each grain, is a power-of-2 number of bits. Grain size can potentially differ across different MCMs, provided that data transmitted between them is sized and aligned to the largest grain of the sender-receiver pair.

If arbitrary alignment and size are to be supported, the granularity may be that of the smallest element size supported. For example, granularity may be one byte if the smallest element size is 8 bits. It may be smaller if smaller elements are supported, such as 4 bits, 2 bits, or even 1 bit. Most neural networks, such as YOLO, do not require very fine granularity: even though the input image nominally has single-element granularity given the odd number of channels (3), image data is forwarded to alignment buffers one memory word at a time and the 255 channels of its last layers might easily be padded with an extra unused channel to round up the size (e.g., to be ignored by software).

An example data flow interface may comprise some or all of the following signals:

TABLE 3
Signals of an example data flow.

| Signal | Size | Description |
|---|---|---|
| rxaddr | (variable) | Destination address (module |
| | | ID, node ID, node input |
| | | selector). |
| sourceID | (variable) | The ID (module, node, or |
| | | otherwise) of the sender. |
| data | mem_width | Data being sent. |
| | (or 2 * | |
| | mem_width ?) | |
| mask | mem_width/ | Enable mask, indicating which |
| | granularity | parts of data are being sent |
| | | when less than mem_width. |
| size | log₂(mem_width/ | How much data to send. 0 < |
| | granularity) | size < mem_width |
| offset | log₂(mem_width) − | Offset of data sent within |
| | log₂(granularity) | the data field. |
| flags | (small) | A set of bits with various |
| | | information about this data. |
| stream_offset | log₂(max strm.ofs/ | Used to indicate out-of-sequence |
| | granularity) | data in the tensor stream. |
| stream_advance | log₂(max strm.ofs/ | How much out-of-sequence data |
| | granularity) | already sent is now in sequence. |

Rxaddr: Nominally, the destination address (rxaddr) may include 3 subfields: MCM ID, node ID, and node input selector. In practice, it is more efficient to allocate these in the destination address space than allocate specific address bits for each. For example, nodes with a single input might use a single address, and nodes with up to 4 inputs might each take 4 consecutive aligned addresses. Each component of the address still needs to be aligned to powers of 2 for efficient routing. For example, if there are 100 Cony nodes, 128 entries are allocated for them. The set of all IDs in a MCM is also rounded up to a power of 2: each MCM might take a different amount of ID space. Requests to an address outside the space of the current MCM get routed to “Connections to Other MCMs” where it is routed to the correct MCM, then to the destination node within it. It is possible to have a special MCM ID (for example zero, or maybe a separate bit) refer to the current one, for local connections without reference to the whole SoC. MCM IDs, node IDs and node input selector indices may be assigned at design time, or at MCM construction time.

SourceID: Every node or component that can send data through a Data Interconnect may be assigned a unique source ID. If a single component can send to up to N destinations (within a single inference session), it has N unique source IDs, generally contiguous. These IDs are assigned at design time, or at MCM construction time.

Data: At least one element and up to mem_width of data being sent. Data may be contiguous. When transmitting less than mem_width of data, the transmission can begin at the start of the data field, or at some other more natural alignment. If dual-banked RAM buffers are used, it may be desirable to support a data field of 2*mem_width for aligned transfers, if the number of wires to route for the given memory width can be achieved in practice.

Mask: The mask is a bitfield with a bit per grain indicating which parts of data are being sent. Data may be anticipated to be contiguous. As such, the mask field is redundant with size and offset fields. An implementation may end up with only mask or only size and offset, rather than both.

Size: Size of data sent, in grains. It is always greater than zero, and no larger than the data field (generally, mem_width).

Offset: Start of data sent within the data field, in grains.

Flags: Set of bits with various information about the data being sent. Most of these flags are sent by scanner readers indicating kernel boundaries to their corresponding Convolution nodes so that the latter need not redundantly track progression of convolution kernels. An example embodiment may implement the following flag bits:

TABLE 4
Example flag bits.

| Flag | Bit | Description |
|---|---|---|
| EOC | 0 | End-of-cycle, or end-of-channels, or end-of-cell. Set to 1 by |
| | | scanner readers when data contains the last channel of a cell |
| | | and perhaps by other nodes in similar circumstances. |
| EOK | 1 | End-of-kernel. Set to 1 by scanner readers when data contains |
| | | the last element of a kernel; data from a subsequent kernel |
| | | is never included in this case. |
| PPK | 2 | Preface-pooling kernel. If MaxPool fusion with Convolution |
| | | is supported, there are two kernels involved: the Convolution |
| | | kernel (or simply “kernel”), each invocation of which |
| | | produces a cell used by the next layer's MaxPool kernel (the |
| | | “pooling kernel”). The PPK flag bit is set to 1 if data |
| | | is for a kernel that is not the last one used by the pooling |
| | | kernel. This tells the Convolution node to keep corresponding |
| | | convolution results for computing Max results rather than send |
| | | them onwards. |
| EOR | 3 | End-of-row. Set to 1 by scanner readers (and perhaps other |
| | | nodes) at the end of an image/tensor row. |
| EOT | 4 | End-of-tensor. Set to 1 when this is the last data sent for |
| | | a given sample in a batch; data from the next sample is never |
| | | included in this case. This flag potentially applies to any |
| | | stream. |
| EOB | 5 | End-of-batch. Set to 1 when this is the last data sent for |
| | | a batch of data (a sequence of tensors), which is usually |
| | | after one complete inference. This flag potentially applies |
| | | to any stream. |

Stream_offset: The stream_offset field indicates out-of-sequence data. It is the number of grains past the current position in the stream, at which data sent starts (at which actual sent data starts, or in other words at which data+offset starts). This field might in principle be as large as the largest tensor minus one grain; in practice, the maximum size needed is much less, and is usually limited by the maximum size of a destination's buffer. Data with a non-zero stream_offset does not advance the current stream position; it must have a zero stream_advance. Only specific types of nodes may be permitted to emit non-zero stream_offset, and only specific types of nodes can accept it; software may be configured to ensure these constraints are met.

Stream_advance: The stream_advance field indicates the number of grains by which the current stream position advances. If stream_offset is non-zero, stream_advance must be zero. If stream_offset is zero, stream_advance is always at least as large as size. It is larger when previously sent out-of-sequence data contiguously follows this packet's data. In this case, stream_advance must include the entire contiguous extent of such previously sent data that is now in sequence. Otherwise, it may be necessary to send data redundantly. One of stream_offset and stream_advance may always be zero. Hardware may thus combine both fields, adding a bit to indicate which is being sent.

Flow Control

In order to send only data that the destination is ready to receive (avoiding complications and inefficiencies of retransmission), each sender may track how many grains of data the destination is ready to receive. In data communication terms, this element may be referred to as the transmission window (e.g., the “send window” to the sender, the “receive window” to the destination). Each sender may track the size of this window: it may initially be zero, and may increase as the destination sends it updates to open the window, and decrease as the sender sends data (e.g., it decreases according to stream_advance). Forward data and flow control paths are asynchronous. Their only timing relationship is that a sender cannot send data until it sees the window update that allows sending that data.

The window may start out as zero, which requires each destination to send an initial update before the sender can send anything, or the window may start as mem_width. Alternatively, perhaps this can vary per type of sender or destination: perhaps for some senders, software can initialize the window before initiating inference. The flow control interface communicates window updates from sender to receiver. It may include the following signals:

TABLE 5
Flow control interface signals.

| Signal | Size | Description |
|---|---|---|
| sourceID | (variable) | Recipient of this packet. (“Source” is in |
| | | terms of forward flow.) |
| flags | (small) | A set of bits with various information. |
| delta_window | log₂(max | How much more data the receiver can now |
| | strm.ofs) | accept. |

SourceID: The sender's source ID to which to send this update.

Flags: Set of bits with various information about this window update (or send alongside it).

One or more update flag bits may be defined, such as a WINWAIT flag. The transmission window will not increase until potentially all data in the window is received. The window “waits” for data. This WINWAIT flag bit may help to efficiently implement chunking of sent data, like TCP's Nagle without the highly undesirable timeouts. With chunking, a sender may send only a full mem_width (or other such size) of data at a time, to improve efficiency. However, if the recipient will not be able to receive that mem_width of data until more data is received, not sending may cause deadlock. If the WINWAIT bit is set, and the sender has enough data to fill the window, it must send this data even if it's not a full chunk. If the WINWAIT bit is set, the data sender receiving it must assume it to be set until it has sent the entire current window or received a subsequent window update, whichever comes first.

Delta_window: This signal may indicate the number of extra grains of data the sender can now send forward: they are in addition to the current window. It may always be positive. Zero is allowed and might be useful for sending certain flags. This can be the entire tensor size. Unlike other places, this can be the entire batch size, and cross tensor boundaries within a batch.

Data Flow Analysis

One common approach to neural network (NN) computation is to compute one node or layer at a time. Various optimizations exist that involve computing some set of adjacent nodes together. With MCM arrays, this may be particularly relevant. If data movement is to be minimized, each MCM array can only compute the specific convolution(s) whose weights it contains. Thus, to obtain good parallelism and efficiency, it is necessary to compute multiple layers at once. This might be done by computing one layer at a time for a given image, while computing multiple images at once. This is somewhat restrictive in use models. For greater flexibility and potential performance, example embodiments provide for processing multiple layers at once per image.

Described herein are the implications of taking this approach all the way and processing all nodes in parallel fashion, with data flowing through the graph as computation proceeds. Starting with the input image, data flows to the first node(s), and proceeds toward successive nodes along the edges of the neural network graph, much like water streaming down a network of channels (tensor edges) and mechanisms (nodes). Processing is complete when all data has flowed all the way through the last node(s) of the graphs, into output tensors (buffers).

One factor of an efficient implementation involves obtaining optimal throughput with a minimum of resources, in particular buffering (memory) resources along the graph. Each type of node may have specific requirements. Some implementations may be susceptible to blocking in the presence of insufficient buffer resources. Thus, proper tuning and balance of resources may be essential for proper operation, rather than simply optimal performance. Provided below are example terms and metrics that allow describing succinctly how to ensure effective data flow in an example embodiment.

Priming distance: An N×N convolution node for example, processing left to right (widthwise) then top to bottom (heightwise), reads a succession of N×N sub-matrices of the input tensor to compute each cell of the output tensor. Assuming the input tensor was also generated left-to-right then top-to-bottom, a buffer is required to allow reading these N×N sub-matrices from the last N rows of the input tensor. Thus, approximately N×width input cells (N×width×channels elements) of buffering are needed, and up to that many cells must be fed on input before computed data starts showing on the output. This is a key metric for data flow analysis:

The priming distance through a given node is the maximum amount of data that must be fed into that node before it is able to start emitting data at its conversion ratio (as follows). It might not start emitting that data right away if processing takes time, however given enough time, once the priming distance amount of data has been fed in, each X amount of data on input eventually results in Y amount of data on output, without needing more than X to obtain Y. The ratio between Y and X is the conversion ratio and is associated with a granularity or minimum amount of X and/or Y for conversion to proceed. The (total) priming distance along a path from node A to node B may be the maximum amount of data that must be fed into node A before node B starts emitting data at the effective conversion ratio from A to B.

Conversion ratio: The conversion ratio is a natural result of processing. For example, convolutions might have a different number of input and output channels, causing the ratio to be higher or smaller than 1. Or they might use non-unit strides, resulting in a reduction in bandwidth, in other words a ratio less than 1. Where a node has multiple inputs and/or outputs, there is a separate ratio for each input/output pair. Note however that most nodes (all nodes in current implementation) have a single output, sometimes fed to multiple nodes. The ratio is to that single output, regardless of all the nodes to which that single output might be fed.

In an n-ary node (Add, Mul, Mean, etc), in the absence of broadcasting, all inputs accept data at the same rate, and the rate of output is the same as any one of the inputs. Thus, the conversion ratios are all 1.

A Concat node may concatenates along the channel axis. It may accepts the same amount of data, that is the same number of channels, on each input. It can however accept a different number of channels on each input. Assuming multiple inputs, the conversion ratio is always greater than one: the amount of data output is the sum of the amount on all inputs and is thus larger than the amount of data in any one input.

Buffering capacity: The buffering capacity of a node, or more generally of a path from node A to node B, is the (minimum) amount of data that can be fed into node A without any output coming out of node B. (Like priming distance, it is measured at the input of node A.) Buffering capacity may consist of priming distance plus extra buffering capacity, that portion of buffering capacity beyond the initial priming distance.

Ensuring continuous flow and avoiding blocking: The possibility of blocking is a result of the nature of nodes with multiple inputs, where multiple paths of the directed neural network graph merge, together with the variety of buffering along those paths. Multiple input nodes generally process their inputs together at the same rate, or possibly at some fixed relative rates in the case of Concat. For example, in a 2-input node, data received at input A cannot be fully processed until matching data from input B has also been received, and vice-versa.

Each path may need a minimum of data in order for data to flow (the priming distance), and a maximum of data it can hold without output data flow (the buffering capacity). The situation to avoid is that where the maximum along a path between two nodes is reached before (is less than) the minimum along another path between the same two nodes.

In other words, continuous flow can be ensured by enforcing the following rule: The buffering capacity along every path from node A to node B must be as large as the largest priming distance along any path between these same nodes (from node A to node B). This rule relies on a few conditions. One is that of balanced input (described below). Another is that these paths are self-contained: there are no paths into or out of this collection of paths that don't go through both A and B (not counting sub-paths). In practice, the rule is easily met for paths out of this collection by applying the rule to each output endpoint separately; or ultimately, to each NN graph output. Multiple inputs, however, should be considered together.

Balanced inputs: The above rule works when multiple inputs to a node are balanced. That is, when the rates of input are proportional to the sizes of the entire tensors being fed into these inputs. Otherwise, relative positions in each input tensor would diverge as processing progressed, requiring buffering proportional to the sizes of the entire tensors (times the divergence in rates), rather than proportional to the width of the tensors. However, multiple input nodes in neural networks can often be balanced by construction. If they were not balanced, one input would be done before another, which is not compatible with multiple-input nodes as generally defined in neural networks.

Example System Configuration

Elaboration of configurable hardware and associated software generally proceeds from a description of the hardware in some form. The following details an expected flow for this process. MCM configuration, or more generally SoC configuration, may be configured using a hierarchical well-defined data structure.

In this example, the format for storing this data structure in configuration files is YAML. The YAML format is a superset of the widely-used JSON format, with the added ability to support data serialization—in particular, multiple references to the same array or structure—and other features that assist human readability. One benefit of using a widely supported encoding such as YAML or JSON is the availability of simple parsers and generators across a wide variety of languages and platforms. These formats are essentially representations of data structures composed of arrays (aka sequences), structures (aka maps, dictionaries or hashes), and base scalar data types including integers, floating point numbers, strings and booleans. This is sufficient to cover an extremely rich variety of data structures. These data structures are easily processed directly by various software without the need of added layers of parsing and formatting (such as is often required for XML or plain text files). They can also be compactly embedded in embedded software to describe the associated hardware. Separate files describe hardware and software configuration.

Some form of structure typing information is generally useful to clearly document data structures, automatically verify their validity at a basic level, and optionally allow access to data structures through native structure and array types and classes in some languages. Some form of DTD might be used for this.

The hardware or system description may be first written manually by a user, such as in YAML. Software tools may be developed to help decide on appropriate configurations for specific purposes. The system description is then processed by software to verify its validity and produce various derived properties and data structures use by multiple downstream consumers—such as assigning MCM IDs, node IDs, source IDs, calculating their width, and so forth. Hardware choices relevant to software might also be generated in this phase, such as generating the data interconnect network based on topology configuration and calculating latency and throughput along various paths. The resulting automatically-expanded system description may be used by most or all tools from that point on in the build process.

MCM hardware RTL may be generated from this expanded system description. Some portion of SoC level hardware interconnect might also be generated from this description, depending on SoC development flow and providers. MCM driver software and applications may embed this description, or query relevant information from hardware (real or simulated) through its memory map. Various other resources may eventually be generated from this system description.

An example data structure that describes the configuration of a hardware system, in an example embodiment, is provided below. Additional parameters and structures may be added, such as to describe desired connections between modules, and derived or generated parameters.

The top-level node is the system structure. It contains various named nodes which together described the hardware system. One system node is defined below: hem modules[ ], an array of MCM configuration structures.

Each MCM may be configured using a structure with the following fields:
a) name: Name for this MCM, for display purposes.
b) vendor: Vendor ID (32-bit) that identifies the hardware manufacturer or vendor. This is normally a JEDEC standard manufacturer ID code, encoded here in a manner similar to the RISC-V mvendorid register. The lower 7 bits are the lower 7 bits of the JEDEC manufacturer ID's terminating one-byte ID, and the next 9 bits indicate the number of 0x7F continuing code bytes, in other words one less than the JEDEC “bank number”. The remaining upper 16 bits are not yet specified.
c) Hardware manufacturers generally already have a JEDEC ID assigned.
d) variant Product ID/type (32-bit), possibly with bitmask indication of major features present. The format and encoding of this field is not yet defined.
e) versionHardware release and version ID (32-bit), composed of 4 fields:
   i. [31:24] maj or version (incremented on major, incompatible changes)
   ii. [23:16] feature version (new features and functionality, backward compatible)
   iii. [15:8] minor version (bug fixes, minor changes not generally affecting compatibility)
   iv. [7:0] revision (ECO/hardware mask/SoC/etc changes)
f) config_id: Unique number (64-bit) identifying this configuration of hardware.

Software can use this to match against a list of known MCM configurations. The configuration ID might be randomly generated at hardware generation time, computed as a hash of a normalized form of the configuration data structure, or allocated by some centralized process at hardware generation time.
g) n_arrays: Number of MCM arrays
h) n_rows: Number of rows per MCM array. This parameter may be changed to allow specifying arrays of different sizes within a module.
i) n_cols: Number of columns per MCM array, and per ADC and output-buffer. This parameter may be changed to allow specifying arrays and ADCs of different sizes within a module.
j) n_ADCs: Number of analog-to-digital converter blocks, each n_cols wide
k) n_outbufs: Number of MCM output buffers, each n_cols wide
l) n_buffers: Number of buffer nodes (each managing a separate buffer within the MCM's shared buffer RAM)
m) n_readers: Number of buffer readers
n) n_hemconvs: Number of FusedConvolution nodes
o) n_concats: Number of Concat nodes
p) n_pools: Number of MaxPool nodes
q) n_narys: Number of N-ary (Add, Mul, etc) nodes
r) mem_width: Memory width in bits, used across the MCM (RAM buffer, all data flows, etc.). It may be advantageous to configure certain parts of the MCM with different widths, such as to reduce area where the performance impact is not significant.
s) membuf_size: Size of buffer RAM, in bytes
t) settle_time: Number of cycles for MCM array RBUF input to settle before computation may begin
u) compute_time: Number of cycles for MCM array computation to complete

Neural Network Compiler

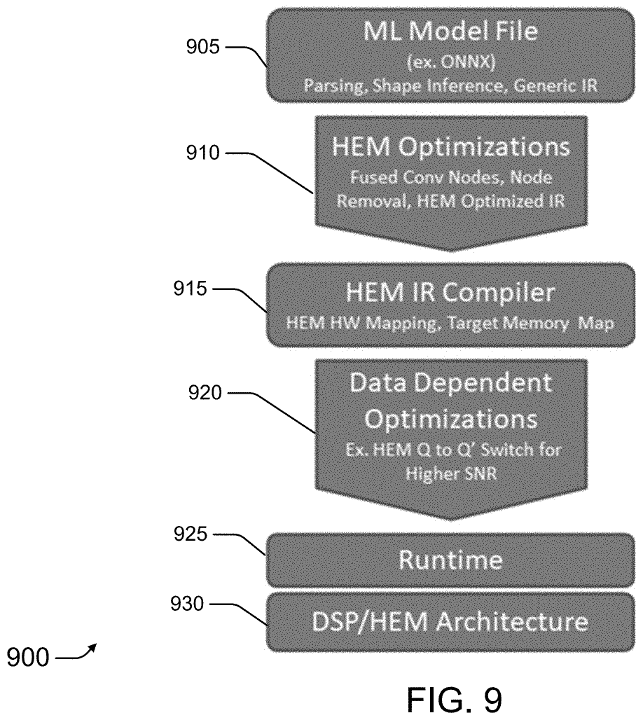

FIG. 9 is a flow diagram illustrating a process 900 of compilation of a neural network in an example embodiment. One consideration of an MCM accelerator is the need to translate neural network models specified at the application layer into a representation, and ultimately a set of instructions, to be run on the processor. As shown in FIG. 9, a machine learning model file 905 created by a user serves as input to the compiler. This model file can be created in a variety of machine learning framework, such as ONNX, Tensorflow, and Pytorch.

The input ONNX model is then parsed into distinct nodes and functions (such as the convolution, maxpool, and ReLU activation function described earlier in the context of YOLOv5s). In this way, a generic internal representation is created for the neural network graph specified by the model file, independent of the machine learning framework or the MCM array in its basic structure while maintaining extensible support for both. Shape inference is then performed to translate the tensor shapes specified in the model into vectors and matrices, a process that is fully bi-directional and contains checks for inconsistencies.

MCM specific optimizations are then performed on the generic internal representation to generate a MCM optimized internal representation (910). For example, MCM-specific fused convolution nodes combine Convolution, ReLU activation, and non-overlapping Max Pooling nodes to directly map to a MCM array module, adjusting other nodes accordingly by re-running full shape inference checking and removing nodes no longer needed. Other MCM specific nodes for graph split and merge and overlapping max pool (calculations that can benefit from alignment buffers) can also be incorporated.

The MCM internal representation compiler then maps the optimized internal representation onto the physical set of MCM arrays (915). This is done on target, in application code. The target memory map is also considered, detailing how application data is routed through memory to MCM arrays. This serves as the primary interface between application and the MCM array and is independent of internal representation and other application-level concerns. Data dependent optimizations include switching from Q to Q′ as the output column lines in MCM arrays when the VMM computation in a column is very sparse (low resulting current in the MCM array column), as well as dynamic quantization of 1-8 bits depending on the precision needs of applications using various combinations of machine learning model and input data (920). Finally, the application has been compiled and executes in the run time environment (925), using the DSP and MCM architecture previously described (930).

As an example, consider use of the neural network compiler on the state-of-the-art object detection neural network YOLOv5. This network can also be extended with additional neural network capabilities for multi-object tracking and segmentation (MOTS).

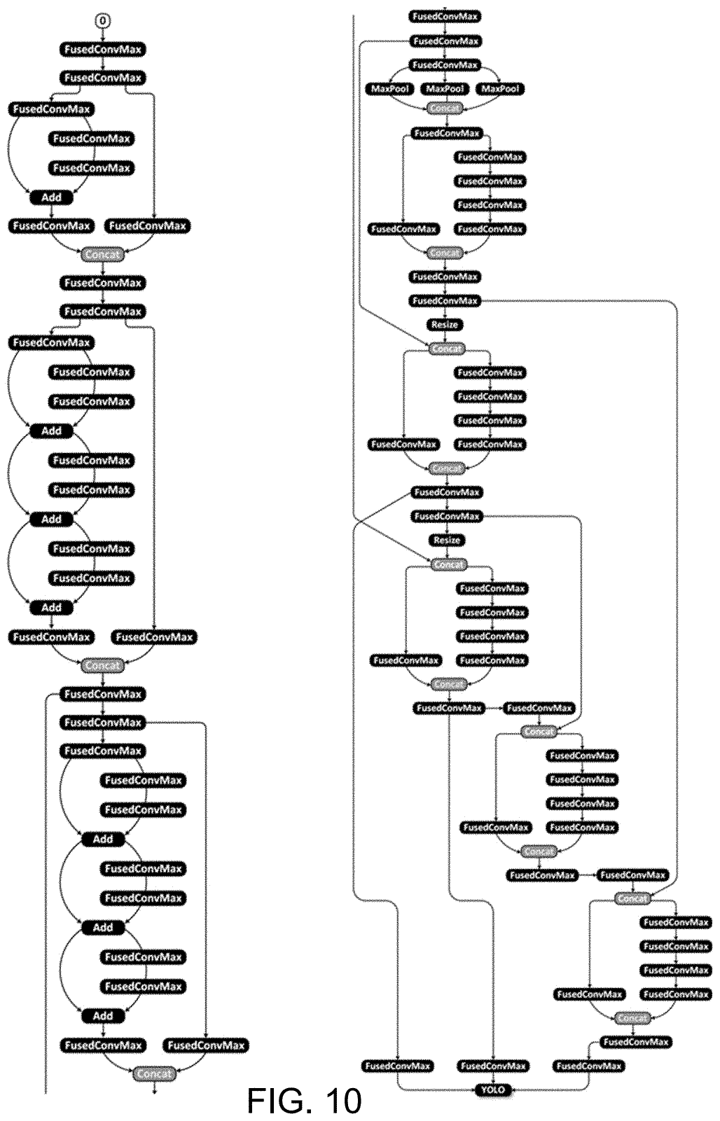

FIG. 10 is a flow diagram of a compiled model neural network in one embodiment, being a YOLOv5 model as instantiated in the system. The diagram has been broken into two halves for clarity of illustration. The first half of the network is depicted on the left, while the adjoining half is on the right. As can be seen, it consists of several different node types, the bulk of which are FusedConvMax layers which are run on the MCM array. A key piece of the neural network compiler is to optimize layer nodes specified in machine learning model files for implementation on MCM hardware modules. Fusing convolution, max pooling, and ReLU nodes and instantiating them on MCM arrays as a single ‘FusedConvMax’ operation, as discussed earlier, is prevalent in this example.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A circuit comprising:
a plurality of memory computation modules (MCMs), each of the MCMs comprising a plurality of memory arrays and a respective module controller configured to 1) program the plurality of memory arrays to perform mathematical operations on a data set and 2) communicate with other of the MCMs to control a data flow between the MCMs;
an inter-module interconnect configured to transport operational data between at least a subset of the MCMs, the inter-module interconnect further configured to maintain a plurality of queues storing at least a subset of the operational data during transport between the subset of the MCMs;
a digital signal processor (DSP) configured to transmit input data to the plurality of MCMs and retrieve output data from the plurality of MCMs.

2. The circuit of claim 1, wherein the module controller of each MCM includes an interface unit configured to parse the input data and store parsed input data to a buffer.

3. The circuit of claim 1, wherein the module controller of each MCM includes a convolution node configured to determine a distribution of the data set among the plurality of memory arrays.

4. The circuit of claim 1, wherein the module controller of each MCM includes one or more alignment buffers configured to enable multiple memory arrays to be written with data of the data set simultaneously using a single memory word read.

5. The circuit of claim 4, wherein the module controller of each MCM is further configured to operate a number of the one or more alignment buffers based on a number of convolution kernel rows.

6. The circuit of claim 4, wherein the module controller of each MCM further includes one or more barrel shifters each configured to shift an output of the one or more alignment buffers into an array row buffer, the array row buffer configured to provide input data to a respective row of one of the plurality of memory arrays.

7. The circuit of claim 1, wherein the mathematical operations include vector matrix multiplication (VMM).

8. The circuit of claim 1, wherein the plurality of MCMs are configured to perform mathematical operations associated with a common computation operation, the data set being associated with the common computation operation.

9. The circuit of claim 8, wherein the common computation operation is one of a computational graph defined by a neural network, a dot product computation, and a cosine similarity computation.

10. The circuit of claim 1, wherein the inter-module interconnect is configured to transport the operational data as data segments, the data segments having a bit size equal to a whole number raised to a power of 2.

11. The circuit of claim 10, wherein the inter-module interconnect is further configured to control a data segment to have a size and alignment corresponding to a largest data segment transported between two MCMs.

12. The circuit of claim 1, wherein the inter-module interconnect is configured to generate a data flow between two MCMs, the data flow including at least one data packet having a mask field, a data size field, and an offset field.

13. The circuit of claim 12, wherein the at least one packet further includes a stream control field, the stream control field indicating whether to advance or offset a data stream.

14. The circuit of claim 1, wherein the plurality of MCMs includes a first MCM and a second MCM, the first MCM being configured to maintain a transmission window, the transmission window indicating a maximum quantity of the operational data permitted to be transferred from the first MCM to the second MCM.

15. The circuit of claim 14, wherein the first MCM is configured to increase the transmission window based on a signal from the second MCM, and is configured to decrease the transmission window based on a quantity of data transmitted to the second MCM.

16. A memory computation module (MCM) circuit, comprising:
a plurality of memory arrays configured to perform mathematical operations on a data set;
an interface unit configured to parse input data and store parsed input data to a buffer;
a convolution node configured to determine a distribution of the data set among the plurality of memory arrays;
one or more alignment buffers configured to enable multiple memory arrays to be written with data of the data set simultaneously using a single memory word read; and
an output node configured to process a computed data set output by the plurality of memory arrays.

17. The circuit of claim 16, wherein the plurality of memory arrays are high-endurance memory (HEM) arrays.

18. The circuit of claim 16, wherein the circuit is configured to operate a number of the one or more alignment buffers based on a number of convolution kernel rows.

19. The circuit of claim 16, further comprising one or more barrel shifters each configured to shift an output of the one or more alignment buffers into an array row buffer, the array row buffer configured to provide input data to a respective row of one of the plurality of memory arrays.

20. A method of computation, comprising:
at a memory computation module (MCM) comprising a plurality of memory arrays and a module controller configured to program the plurality of memory arrays to perform mathematical operations on a data set:
parsing input data via a reader node;
storing the input data to a buffer via a buffer node;
reading the input data via a scanner reader node;
at a convolution node, determining a distribution of a data set among the plurality of memory arrays, the data set corresponding to the input data;
at the plurality of memory arrays, processing the data set to generate a data output.

21. The method of claim 20, further comprising, at one or more alignment buffers, enabling multiple memory arrays to be written with data of the data set simultaneously using a single memory word read.

22. The method of claim 20, further comprising, at one or more barrel shifters, shifting an output of the one or more alignment buffers into an array row buffer.

23. A method of compiling a neural network, comprising:
parsing a computation graph of nodes having a plurality of different node types into its constituent nodes;
performing shape inference on input and output tensors of the nodes to specify a computation graph representation of vectors and matrices on which processor hardware is to operate;
generating a modified computation graph representation, the modified computation graph representation being configured to be operated by a plurality of memory computation modules (MCMs);
memory mapping the modified computation graph representation by providing addresses through which MCMs can transfer data; and
generating a runtime executable code based on the modified computation graph representation.

24. The method of claim 23, further comprising shifting data output of memory array cells of the MCMs to a conjugate version in response to vector matrix multiplication in the memory array cells yielding an output current that is below a threshold value.
